(19) United States
(12) Patent Application Publication
(10) Pub. No.: US 2026/0311643 A1
(43) Pub. Date: Oct. 8, 2026

(54) APPARATUS FOR CONTROLLING DISPLAY PANEL AND DISPLAY DEVICE INCLUDING THE SAME

(71) Applicant: LX SEMICON CO., LTD., Daejeon (KR)

(72) Inventor: Seok Hoo KIM, Daejeon (KR)

(73) Assignee: LX SEMICON CO., LTD., Daejeon (KR)

(21) Appl. No.: 19/632,849

(22) Filed: Mar. 30, 2026

(30) Foreign Application Priority Data
Apr. 4, 2025 (KR) 10-2025-0044018

(51) Int. Cl. G09G 3/3233; G09G 3/20

(52) U.S. Cl. CPC G09G 3/3233; G09G 3/2096; G09G 2300/0842; G09G 2310/08; G09G 2370/10

(57) ABSTRACT

A display panel control apparatus according to an aspect of the present disclosure capable of blocking simultaneous access of an external device and a timing controller to a storage device, comprises a timing controller configured to control driving of a display panel including a plurality of pixels, a storage device in which at least one of setting data of the timing controller and compensation data for compensating characteristic values of the plurality of pixels is stored, and a first routing line configured to connect an external device configured to record or update the setting data and the timing controller, wherein the external device accesses the storage device through the timing controller to record or update the setting data.

### CROSS-REFERENCE TO RELATED APPLICATION

This application claims the priority of Korean Patent Application No. 10-2025-0044018 filed on Apr. 04, 2025, which is hereby incorporated by reference in its entirety.

### BACKGROUND

### Field of the Disclosure

The present disclosure relates to a display device, and more particularly, to a display panel control apparatus.

### Description of the Background

As information technology advances, various display devices capable of visualizing information have been developed. Examples of such display devices include liquid crystal display (LCD) devices, organic light emitting diode (OLED) display devices, plasma display panel (PDP) devices, and the like. These display devices are being developed to appropriately display high-resolution images.

A display device includes a display panel having a plurality of pixels defined by a plurality of gate lines and a plurality of data lines, a gate driving circuit configured to supply gate signals to the gate lines, a data driving circuit configured to supply data voltages to the data lines, and a display panel control apparatus configured to control operations of the gate driving circuit and the data driving circuit.

As shown in FIG. 1, a general display panel control apparatus 10 includes a printed circuit board (PCB) 20, a timing controller 30, a storage device 40, and a connector 60. The timing controller 30, the storage device 40, and the connector 60 are mounted on the printed circuit board 20.

The timing controller 30 may, upon booting, read firmware data for operating the timing controller 30, setting data, icon data, or compensation value data from the storage device 40, or may write newly generated compensation value data, obtained through real-time sensing, to the storage device 40.

Meanwhile, when it is necessary to update firmware data, setting data, icon data, or the like stored in the storage device 40, an external device 50 is connected to the storage device 40 through the connector 60 so that the corresponding data can be updated.

As described above, since both the timing controller 30 and the external device 50 are required to be connectable to the storage device 40, the general display control apparatus 10 shown in FIG. 1 includes a T-shaped routing line 70, through which the timing controller 30 and the external device 50 can be connected to the storage device 40.

However, as shown in FIG. 1, when the timing controller 30 and the external device 50 are connected to the storage device 40 through the T-shaped routing line 70, the external device 50 and the timing controller 30 may be simultaneously connected to the storage device 40, which may cause errors due to signal conflicts.

In addition, when data are transmitted and received via the T-shaped routing line 70, data transmission and reception speeds may be reduced, thereby degrading the performance of the display device.

### SUMMARY

The present disclosure is directed to provide a display panel control apparatus capable of blocking simultaneous access of an external device and a timing controller to a storage device, and a display device including the same.

The present disclosure is directed to provide a display panel control apparatus in which the external device can access the storage device only through the timing controller and the timing controller can control whether the external device accesses the storage device, and a display device including the same.

The present disclosure is directed to provide a display panel control apparatus capable of updating setting data using an external device without error during a display operation by the timing controller, and a display device including the same.

According to an aspect of the present disclosure, there is provided a display panel control apparatus for achieving the aforementioned technical advantages comprising: a timing controller configured to control driving of a display panel including a plurality of pixels, a storage device in which at least one of setting data of the timing controller and compensation data for compensating characteristic values of the plurality of pixels is stored, and a first routing line configured to connect an external device configured to record or update the setting data and the timing controller, wherein the external device accesses the storage device through the timing controller to record or update the setting data.

According to an aspect of the present disclosure, there is provided a display device for achieving the aforementioned technical advantages comprising: a display panel including a plurality of pixels, a control printed circuit board (PCB) connected to the display panel, a timing controller mounted on the control printed circuit board and configured to control driving of the display panel, a storage device mounted on the control printed circuit board, in which at least one of setting data of the timing controller and compensation data for compensating characteristic values of the plurality of pixels is stored, and an external device configured to record or update the setting data, wherein the external device accesses the storage device through the timing controller to record or update the setting data.

### BRIEF DESCRIPTION OF THE DRAWINGS

The accompanying drawings, which are included to provide a further understanding of the disclosure and are incorporated in and constitute a part of this application, illustrate aspects of the disclosure and together with the description serve to explain the principle of the disclosure.

In the drawings:

FIG. 1 schematically illustrates a configuration of a conventional display panel control apparatus;

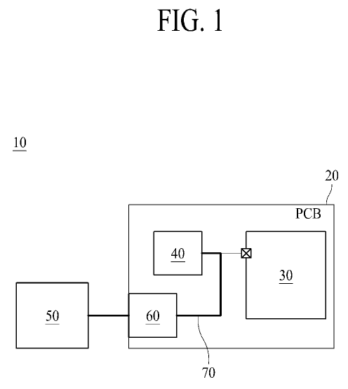

FIG. 2 illustrates a configuration of a display device including a display panel control apparatus according to an aspect of the present disclosure;

FIG. 3 illustrates an implementation example of a display device according to an aspect of the present disclosure; and

FIG. 4 is a block diagram showing a configuration of a display panel control apparatus according to an aspect of the present disclosure.

### DETAILED DESCRIPTION

Like reference numerals refer to like elements throughout. In the following description, when the detailed description of the relevant known function or configuration is determined to unnecessarily obscure the important point of the present disclosure, the detailed description will be omitted.

Advantages and features of the present disclosure, and implementation methods thereof will be clarified through following exemplary aspects described with reference to the accompanying drawings. The present disclosure may, however, be embodied in different forms and should not be construed as limited to the exemplary aspects set forth herein. Rather, these exemplary aspects are provided so that this disclosure will be thorough and complete, and will fully convey the scope of the present disclosure to those skilled in the art. Further, the present disclosure is only defined by scopes of claims.

A shape, a size, a ratio, an angle, and a number disclosed in the drawings for describing exemplary aspects of the present disclosure are merely an example, and thus, the present disclosure is not limited to the illustrated details.

In a case where “include,” “have,” “comprise,” “contain,” “constitute,” “make up of,” “formed of,” and “consist of” described in the present specification are used, another part can be added unless ‘only~’ is used. The terms of a singular form can include plural forms unless referred to the contrary.

In construing an element, the element is construed as including an error range although there is no explicit description.

In describing a position relationship, for example, when a position relation between two parts is described as “on”, “above”, “over”, “below”, “under”, “beside”, “beneath”, “near”, “close to, ” “adjacent to”, “on a side of”, “next”, one or more other parts may be disposed between the two parts unless ‘just’ or ‘direct’ is used.

It will be understood that, although the terms “first”, “second” etc. can be used herein to describe various elements, these elements should not be limited by these terms. These terms are only used to distinguish one element from another. Accordingly, a first element mentioned hereinafter could be termed a second element without departing from the scope of the present disclosure.

The term “at least one” should be understood as including any and all combinations of one or more of the associated listed items. For example, the meaning of “at least one of a first item, a second item, and a third item” denotes each of the first item, the second item, and the third item as well as the combination of all items proposed from two or more of the first item, the second item, and the third item.

Features of various exemplary aspects of the present disclosure can be partially or overall coupled to or combined with each other and can be variously inter-operated or combined with each other and driven technically as those skilled in the art can sufficiently understand. The exemplary aspects of the present disclosure can be carried out independently from each other, or can be carried out together in co-dependent relationship.

Hereinafter, example aspects of the present disclosure will be described in detail with reference to the accompanying drawings.

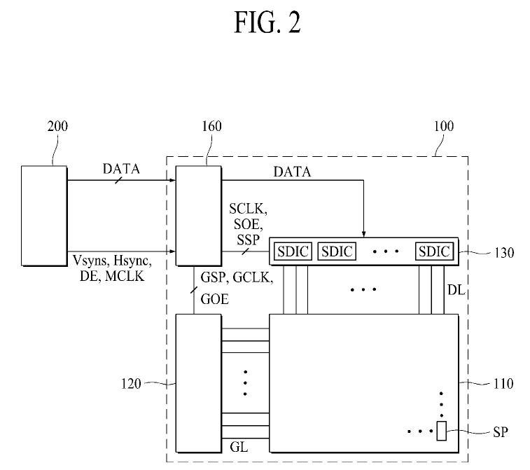

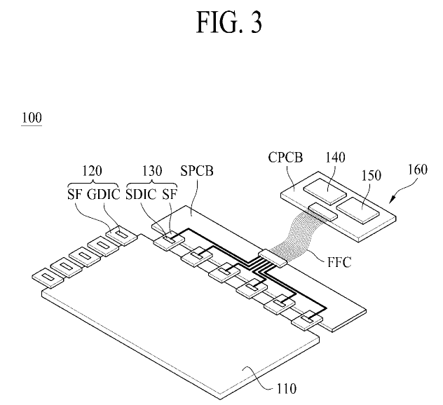

FIG. 2 illustrates a configuration of a display device including a display panel control apparatus according to an aspect of the present disclosure and FIG. 3 illustrates an implementation example of a display device according to an aspect of the present disclosure.

The display device 100 shown in FIGS. 2 and 3 is an electronic device including a display panel control apparatus according to the present disclosure. For example, the display device 100 may be various display devices using a voltage of a battery or an external power source as an operating voltage. In one aspect, the display device 100 may be a vehicle display device mounted in a vehicle.

Referring to FIG. 2, the display device 100 according to the present disclosure includes a display panel 110 in which a plurality of gate lines GL and a plurality of data lines DL are connected and a plurality of sub-pixels SP are arranged in a matrix form, a gate driving circuit 120 for driving the plurality of gate lines GL, a data driving circuit 130 for supplying data voltages through the plurality of data lines DL, and a display panel control apparatus 160 for controlling the gate driving circuit 120 and the data driving circuit 130.

In particular, the display panel control apparatus 160 according to the present disclosure may include a timing controller 140 and a storage device 150 mounted on a control printed circuit board (CPCB) as shown in FIG. 3.

The display panel 110 displays an image based on scan signals transferred from the gate driving circuit 120 through the plurality of gate lines GL and data voltages transferred from the data driving circuit 130 through the plurality of data lines DL.

In one aspect, the display panel 110 may be a liquid crystal display panel. When the display panel 110 is a liquid crystal display panel, the display panel 110 includes a liquid crystal layer formed between two substrates, and may operate in any known mode such as a twisted nematic (TN) mode, a vertical alignment (VA) mode, an in-plane switching (IPS) mode, a fringe field switching (FFS) mode, or the like.

In another aspect, the display panel 110 may be an organic light emitting diode (OLED) display panel. When the display panel 110 is an organic light emitting diode display panel, the display panel 110 may be implemented in a top emission type, a bottom emission type, a dual emission type, or the like.

Hereinafter, for convenience of description, it is assumed that the display panel 110 is an organic light emitting diode display panel.

The display panel 110 may have a plurality of pixels arranged in a matrix form, and each pixel may include sub-pixels SP of different colors, for example, a white sub-pixel, a red sub-pixel, a green sub-pixel, and a blue sub-pixel, and each sub-pixel SP may be defined by the plurality of data lines DL and the plurality of gate lines GL.

One sub-pixel SP may include a thin film transistor (TFT) formed in an area where one data line DL and one gate line GL intersect, an organic light emitting diode, a storage capacitor for electrically connecting to the organic light emitting diode to maintain a voltage, and the like. An image may be displayed by controlling a current flowing through the organic light emitting diode disposed in each sub-pixel SP.

The gate driving circuit 120 is controlled by the timing controller 140. The gate driving circuit 120 sequentially outputs scan signals to a plurality of gate lines GL disposed in the display panel 110 to control driving timing of the plurality of sub-pixels SP.

As shown in FIG. 3, the gate driving circuit 120 may include at least one gate drive integrated circuit (GDIC) and may be located on one side or both sides of the display panel 110 depending on a driving method. In another aspect, the gate driving circuit 120 may be embedded in a bezel area of the display panel 110 and implemented in a gate in panel (GIP) type.

One or more gate drive integrated circuits (GDICs) included in the gate driving circuit 120 may be mounted on a gate film (GF), respectively, and one side of the gate film (GF) may be electrically connected to the display panel 110. In addition, wirings for electrically connecting the gate drive integrated circuit (GDIC) and the display panel 110 may be disposed on the gate film (GF).

The data driving circuit 130 receives image data DATA from the timing controller 140 and converts the received image data DATA into analog data voltages. Then, by outputting the data voltages to respective data lines DL in timing when a scan signal is applied through the gate line GL, each sub-pixel SP connected to the data line DL displays a light emission signal having luminance corresponding to the data voltage.

As shown in FIG. 3, the data driving circuit 130 may include at least one source drive integrated circuit (SDIC). The source drive integrated circuit (SDIC) may be connected to a bonding pad of the display panel 110 in a tape automated bonding (TAB) method or a chip on glass (COG) method, or directly disposed on the display panel 110.

In one aspect, each source drive integrated circuit (SDIC) may be integrated and disposed on the display panel 110. Also, each source drive integrated circuit (SDIC) may be implemented in a chip on film (COF) method, and in this case, each source drive integrated circuit (SDIC) may be mounted on a circuit film and electrically connected to the data line DL of the display panel 110 through the circuit film.

One or more source drive integrated circuits (SDICs) included in the data driving circuit 130 may be mounted on a source film (SF), respectively, and one side of the source film (SF) may be electrically connected to the display panel 110. In addition, wirings for electrically connecting the source drive integrated circuit (SDIC) and the display panel 110 may be disposed on the source film (SF).

At this time, the other side of the source film (SF) on which the source drive integrated circuit (SDIC) is mounted may be connected to at least one source printed circuit board (SPCB). That is, the source film (SF) on which the source drive integrated circuit (SDIC) is mounted may have one side electrically connected to the display panel 110 and the other side electrically connected to the source printed circuit board (SPCB).

The timing controller 140 supplies control signals to the gate driving circuit 120 and the data driving circuit 130 to control operations of the gate driving circuit 120 and the data driving circuit 130. That is, the timing controller 140 controls the gate driving circuit 120 to output scan signals according to timing implemented in each frame, and transfers image data DATA received from outside to the data driving circuit 130 so that the data driving circuit 130 outputs data voltages corresponding to the image data DATA to data lines DL.

At this time, the timing controller 140 may receive, from an external host system 200, timing signals including a vertical synchronization signal Vsync, a horizontal synchronization signal Hsync, a data enable signal DE, and a main clock MCLK together with the image data DATA.

The host system 200 may be any one of a television (TV) system, a set-top box, a navigation system, a personal computer (PC), a home theater system, a mobile device, and a wearable device.

Accordingly, the timing controller 140 generates control signals using the timing signals received from the host system 200 and transfers the control signals to the gate driving circuit 120 and the data driving circuit 130.

For example, in order to control the gate driving circuit 120, the timing controller 140 outputs gate control signals including a gate start pulse GSP, a gate clock GCLK, and a gate output enable signal GOE to the gate driving circuit 120.

Here, the gate start pulse GSP controls a timing at which at least one gate drive integrated circuit (GDIC) constituting the gate driving circuit 120 starts operating. The gate clock GCLK is a clock signal commonly input to at least one gate drive integrated circuit (GDIC) and controls a shift timing of the scan signal. The gate output enable signal GOE designates timing information of at least one gate drive integrated circuit (GDIC).

In addition, in order to control the data driving circuit 130, the timing controller 140 outputs data control signals including a source start pulse SSP, a source sampling clock SCLK, and a source output enable signal SOE to the data driving circuit 130. Here, the source start pulse SSP controls a timing at which at least one source drive integrated circuit (SDIC) constituting the data driving circuit 130 starts data sampling. The source sampling clock SCLK is a clock signal for controlling a timing of sampling data in at least one source drive integrated circuit (SDIC). The source output enable signal SOE controls an output timing of at least one source drive integrated circuit (SDIC).

Further, the timing controller 140 may generate compensation data for compensating a deviation of characteristic values of a driving transistor of the sub-pixel connected to the sensing circuit (not shown) by comparing sensing data received from the sensing circuit with a preset reference value. The timing controller 140 compensates the image data by reflecting the generated compensation data in the image data and may record the generated compensation data in the storage device 150.

As shown in FIG. 3, the timing controller 140 and the storage device 150 may be mounted on a control printed circuit board CPCB. Although not shown in FIG. 3, a power management integrated circuit (PMIC) may be further mounted on the printed circuit board (PCB). The power management integrated circuit supplies various voltages or currents to the display panel 110, the gate driving circuit 120, the data driving circuit 130, and the like or controls the various voltages or currents.

At this time, the control printed circuit board CPCB may be electrically connected to at least one source printed circuit board SPCB through at least one connection member, and the connection member may be, for example, a flexible printed circuit FPC or a flexible flat cable FFC. The connection member connecting at least one source printed circuit board SPCB and the control printed circuit board CPCB may be variously changed according to a size and type of the display device 100, and at least one source printed circuit board SPCB and the control printed circuit board CPCB may be integrated and implemented as a single printed circuit board.

The timing controller 140 as described above may operate using setting data recorded in the storage device 150. In one aspect, the setting data recorded in the storage device 150 may include at least one of a firmware file for driving the timing controller 140, a configuration file, and icon data.

In one aspect, the setting data recorded in the storage device 150 may be recorded using an external device or updated using the external device. In this case, the timing controller 140 according to the present disclosure may control access of the external device to the storage device 150.

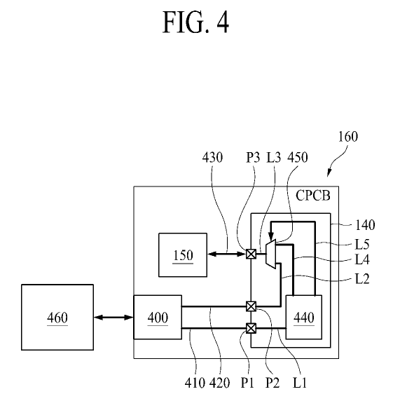

Hereinafter, a display panel control apparatus according to an aspect of the present disclosure including the timing controller as described above will be described in more detail with reference to FIG. 4.

FIG. 4 is a block diagram showing a configuration of a display panel control apparatus according to an aspect of the present disclosure.

As shown in FIG. 4, the display panel control apparatus 160 according to an aspect of the present disclosure includes a control printed circuit board (CPCB), a timing controller 140, a storage device 150, a connector 400, a first routing line 410, a second routing line 420, and a third routing line 430.

The timing controller 140, the storage device 150, the connector 400, the first routing line 410, the second routing line 420, and the third routing line 430 are mounted on the control printed circuit board (CPCB). As described above, the control printed circuit board (CPCB) may be electrically connected to at least one source printed circuit board (SPCB) through a connection member such as a flexible printed circuit (FPC) or a flexible flat cable (FFC).

The timing controller 140 is mounted on the control printed circuit board (CPCB) to be electrically connectable to an external device 460 and the storage device 150, thereby controlling connection of the external device 460 to the storage device 150.

Specifically, the timing controller 140 is connected to the external device 460 through a first pin P1, the first routing line 410, and the connector 400 to receive an access enable signal for accessing the storage device 150 from the external device 460. The timing controller 140 determines whether to connect the external device 460 to the storage device 150 according to a logic level state of the access enable signal.

Also, the timing controller 140 is connected to the external device 460 through a second pin P2, the second routing line 420, and the connector 400 to receive setting data from the external device 460. When it is determined to connect the external device 460 to the storage device 150 according to the logic level state of the access enable signal, the timing controller 140 allows the setting data received from the external device 460 through the second pin P2, the second routing line 420, and the connector 400 to be recorded in the storage device 150.

Meanwhile, the timing controller 140 is connected to the storage device 150 through a third pin P3 and the third routing line 430. Through this, the timing controller 140 enables setting data transmitted from the external device 460 to be recorded in the storage device 150, reads the setting data recorded in the storage device 150, or records compensation data for compensating characteristic values of each pixel in the storage device 150.

In one aspect, as shown in FIG. 4, the timing controller 140 includes a data controller 440, a mux 450, a first pin P1, a second pin P2, a third pin P3, a first connection line L1, a second connection line L2, a third connection line L3, a fourth connection line L4, and a fifth connection line L5.

The data controller 440 supplies control signals to the gate driving circuit 120 and the data driving circuit 130 to control operations of the gate driving circuit 120 and the data driving circuit 130. Also, the data controller 440 generates compensation data for each pixel based on sensing data of each pixel obtained through a sensing operation and stores the generated compensation data in the storage device 150.

In particular, the data controller 440 according to the present disclosure receives an access enable signal for accessing the storage device 150 from the external device 460 and determines whether to permit access of the external device 460 to the storage device 150 according to a logic level of the access enable signal.

More specifically, the data controller 440 receives the access enable signal from the external device 460 connected to the display panel control apparatus 160 through the connector 400. The data controller 440 determines the logic level of the received access enable signal and connects the external device 460 to the storage device 150 or releases the connection between the storage device 150 and the external device 460 according to the determined logic level.

In one aspect, the data controller 440 receives the access enable signal through a first connection line L1 connected to the first pin P1, and when the logic level of the access enable signal is a first logic level, determines to connect the external device 460 and the storage device 150. For example, when the logic level of the access enable signal is a high level, the data controller 440 determines to connect the external device 460 and the storage device 150.

Meanwhile, when the logic level of the access enable signal is a second logic level, the data controller 440 determines to release the connection between the external device 460 and the storage device 150. For example, when the logic level of the access enable signal is a low level, the data controller 440 determines to release the connection between the external device 460 and the storage device 150.

The data controller 440 generates a selection signal (SEL) for controlling an operation of the mux 450 according to the determined logic level of the access enable signal. In one aspect, when the logic level of the access enable signal is the first logic level, the data controller 440 generates the selection signal (SEL) having a first logic level for connecting the external device 460 to the mux 450 and outputs it to the mux 450.

Meanwhile, when the logic level of the access enable signal is the second logic level, the data controller 440 generates the selection signal (SEL) having a second logic level for releasing the connection between the external device 460 and the mux 450 and connecting the data controller 440 to the mux 450, and outputs it to the mux 450.

The data controller 440 may supply the generated selection signal (SEL) to the mux 450 through a fifth connection line L5.

In one aspect, when the access enable signal having a first logic level is received from the external device 460 while image data is being output through the display panel 110, the data controller 440 may stop outputting the image data and allow predetermined icon data to be output through the display panel 110. Through this, even when an update of setting data is required during a display operation by the data controller 440, the data controller 440 outputs the predetermined icon data to the display panel 110 and then allows the external device 460 to access the storage device 150, thereby enabling the update of the setting data without error even during the display operation.

The mux 450 connects the external device 460 to the storage device 150 or connects the data controller 440 to the storage device 150 according to the selection signal (SEL) transmitted from the data controller 440.

Specifically, when the selection signal (SEL) having the first logic level is received from the data controller 440, the mux 450 connects a second connection line L2 connected to the second pin P2 to a third connection line L3 connected to an output terminal of the mux 450. Accordingly, the setting data received through the second routing line 420 connected to the second pin P2 is recorded in the storage device 150 through the second connection line L2, the mux 450, the third connection line L3, the third pin P3, and the third routing line 430.

Also, when the selection signal (SEL) having the second logic level is received from the data controller 440, the mux 450 connects a fourth connection line L4 connected to the data controller 440 to the third connection line L3 connected to the output terminal of the mux 450. Accordingly, the data controller 440 accesses the storage device 150 through the fourth connection line L4, the mux 450, the third connection line L3, the third pin P3, and the third routing line 430, thereby recording the compensation data in the storage device 150 or reading setting data from the storage device 150.

In one aspect, the mux 450 may be configured with at least one switching element (not shown) for selectively connecting one of the second connection line L2 and the fourth connection line L4 to the third routing line 430.

The storage device 150 records at least one of setting data and compensation data. The storage device 150 is connected to the timing controller 140 through the third routing line 430. That is, the storage device 150 is connected only to the timing controller 140 and not directly connected to the external device 460. Accordingly, simultaneous access of the timing controller 140 and the external device 460 to the storage device 150 can be prevented in advance.

In one aspect, the storage device 150 may be a flash memory.

The connector 400 is mounted on the control printed circuit board (CPCB) to allow the external device 460 to access the display panel control apparatus 160. The connector 400 is connected to the first pin P1 of the timing controller 140 through the first routing line 410 and connected to the second pin P2 of the timing controller 140 through the second routing line 420.

The external device 460 accesses the display panel control apparatus 160 through the connector 400 to record setting data in the storage device 150 of the display panel control apparatus 160 or update the setting data recorded in the storage device 150.

In particular, the external device 460 according to the present disclosure may generate an access enable signal for accessing the storage device 150 and transmit it to the timing controller 140. In one aspect, when access to the timing controller 140 is required, the external device 460 generates the access enable signal having a first logic level and transmits it to the timing controller 140, and when access to the timing controller 140 is not required, generates the access enable signal having a second logic level and transmits it to the timing controller 140.

In one aspect, the external device 460 may be a laptop computer or a system on chip (SoC) of an electronic device on which the display device 100 is mounted, and the external device 460 may transmit setting data to the timing controller 140 using an SPI protocol or an I2C protocol.

According to the present disclosure, since the external device can access the storage device only through the timing controller, simultaneous access of the external device and the timing controller to the storage device can be prevented, thereby preventing in advance an occurrence of an error due to the simultaneous access of the external device and the timing controller to the storage device.

Furthermore, according to the present disclosure, the timing controller receives an access enable signal from the external device and can control the external device or the timing controller so that only one of the external device or the timing controller accesses the storage device according to a level of the access enable signal, thereby facilitating more easy and accurate access control of the external device and the timing controller to the storage device.

Furthermore, according to the present disclosure, since the external device can access the storage device only through the timing controller, the external device, the timing controller, and the storage device can be connected using only a straight routing line without a T-shaped routing line, thereby preventing degradation of a data transmission speed.

Furthermore, according to the present disclosure, when an update of setting data is required during a display operation by the timing controller, the timing controller outputs predetermined icon data to the display panel and then allows the external device to access the storage device through the timing controller, thereby enabling update of the setting data without error even during the display operation.

A person skilled in the art to which the present disclosure pertains will understand that the present disclosure described above may be implemented in other specific forms without changing its technical idea or characteristics.

Therefore, it should be understood that the aspects described above are exemplary in all respects and not limiting. The scope of the present disclosure is indicated by the claims described below rather than the detailed description, and all changes or modifications derived from the meaning and scope of the claims and their equivalent concepts should be interpreted as being included in the scope of the present disclosure.

What is claimed is:

1. A display panel control apparatus comprising:
a timing controller configured to control driving of a display panel including a plurality of pixels;
a storage device in which at least one of setting data of the timing controller and compensation data for compensating characteristic values of the plurality of pixels is stored; and
a first routing line configured to connect an external device configured to record or update the setting data and the timing controller,
wherein the external device accesses the storage device through the timing controller to record or update the setting data.

2. The display panel control apparatus of claim 1, further comprising:
a second routing line configured to receive an access enable signal for access to the storage device from the external device and deliver the access enable signal to the timing controller,
wherein the timing controller connects the external device to the storage device when the access enable signal is at a first logic level, and releases the connection between the external device and the storage device when the access enable signal is at a second logic level.

3. The display panel control apparatus of claim 2, further comprising:
a third routing line configured to connect the timing controller to the storage device,
wherein the timing controller comprises:
a data controller configured to determine whether to connect the external device to the storage device based on the access enable signal; and
a mux configured to selectively connect one of the data controller and the external device to the third routing line according to the control of the data controller,
wherein the data controller generates a selection signal for controlling operation of the mux based on the access enable signal and inputs the selection signal to the mux, and
the mux connects the external device to the third routing line when the selection signal is at the first logic level and connects the data controller to the third routing line when the selection signal is at the second logic level.

4. The display panel control apparatus of claim 3, wherein the data controller accesses the storage device when the access enable signal is at the second logic level to read the setting data or the compensation data from the storage device or record new compensation data in the storage device.

5. The display panel control apparatus of claim 3, wherein the timing controller further comprises:
a first pin connected to the first routing line;
a second pin connected to the second routing line; and
a third pin connected to the third routing line.

6. The display panel control apparatus of claim 1, wherein the setting data includes at least one of a firmware file for driving the timing controller, a configuration file, and icon data.

7. The display panel control apparatus of claim 1, wherein the timing controller, when receiving the access enable signal at the first logic level from the external device while image data is being output through the display panel, stops output of the image data and allows predetermined icon data to be output through the display panel.

8. The display panel control apparatus of claim 1, wherein the storage device is a flash memory.

9. The display panel control apparatus of claim 1, wherein the external device transmits the setting data to the timing controller using an SPI protocol or an I2C protocol.

10. A display device comprising:
a display panel including a plurality of pixels;
a control printed circuit board (PCB) connected to the display panel;
a timing controller mounted on the control printed circuit board and configured to control driving of the display panel;
a storage device mounted on the control printed circuit board, in which at least one of setting data of the timing controller and compensation data for compensating characteristic values of the plurality of pixels is stored; and
an external device configured to record or update the setting data,
wherein the external device accesses the storage device through the timing controller to record or update the setting data.

11. The display device of claim 10, wherein the control printed circuit board further comprises:
a first routing line configured to receive the setting data from the external device and transmit the setting data to the timing controller;
a second routing line configured to receive an access enable signal for access to the storage device from the external device and transmit the access enable signal to the timing controller; and
third routing line configured to connect the timing controller to the storage device,
wherein the timing controller connects the external device to the storage device through the first routing line and the third routing line when the access enable signal is at a first logic level, and releases the connection between the external device and the storage device when the access enable signal is at a second logic level.

12. The display device of claim 11, wherein the timing controller comprises:
a data controller configured to determine whether to connect the external device to the storage device based on the access enable signal; and
a mux configured to selectively connect one of the data controller and the external device to the third routing line according to a control of the data controller,
wherein the data controller generates a selection signal for controlling operation of the mux based on the access enable signal and inputs the selection signal to the mux, and
the mux connects the external device to the third routing line when the selection signal is at the first logic level, and connects the data controller to the third routing line when the selection signal is at the second logic level.
